(19) United States
(12) Patent Application Publication
(10) Pub. No.: US 2013/0025074 A1
(43) Pub. Date: Jan. 31, 2013

(54) METHOD FOR OPERATING A WATER-CONTAINING APPLIANCE AND WATER-CONTAINING APPLIANCE

(71) Applicant: BSH BOSCH UND SIEMENS HAUSGERATE GM, Munich (DE)

(72) Inventors: Rüdiger Eiermann, Syrgenstein (DE); Helmut Jerg, Giengen (DE); Reinhard Kimmich, Allensbach (DE)

(73) Assignee: BSH BOSCH UND SIEMENS HAUSGERATE GMBH, Munich (DE)

(21) Appl. No.: 13/644,285

(22) Filed: Oct. 4, 2012

Related U.S. Application Data
(62) Division of application No. 11/043,715, filed on Jan. 26, 2005, now abandoned.
Application No. 11/043,715 is a continuation of application No. PCT/EP2003/008007, filed on Jul. 22, 2003.

(30) Foreign Application Priority Data
Aug. 19, 2002 (DE) 10237854.1

(51) Int. Cl. B08B 7/04; D06L 1/20; B08B 3/08

(52) U.S. Cl. 8/137; 134/18

(57) ABSTRACT

A method of operating a domestic washing appliance is provided for fully dissolving impurities in a cleaning fluid and thereby avoiding turbidity in the cleaning fluid. The method determines the degree of impurity in the cleaning fluid in at least one partial program step using wet combustion and the degree of combustion is established and the method is carried out in a water-guiding device.

### CROSS-REFERENCE TO RELATED APPLICATIONS

This application is a Divisional Application, under 35 U.S.C. §120 and §121, of U.S. application Ser. No. 11/043,715, filed Jan. 26, 2005, which is a Continuation Application under 35 U.S.C. §§120 and 365 (c) of PCT/EP2003/008007, filed Jul. 22, 2003, which designated the United States; this application also claims priority under 35 U.S.C. §119(b) to German Patent Application No. DE 102 37 854.1, filed Aug. 19, 2002; the entire contents of all the above identified patent applications are hereby incorporated by reference.

### FIELD OF THE INVENTION

The present invention relates to a method for operating a water-containing appliance and a water-containing appliance for operating this method, and particularly, a method for operating a domestic washing appliance.

### BACKGROUND OF THE INVENTION

Water-containing appliances presently on the market, e.g. dishwashers, especially domestic dishwashers or washing machines, especially domestic washing machines, usually have a control device—a program controller—with which a cleaning program, which can be composed of partial program steps, is operated and on which a cleaning program selected by the user with pre-set and/or selectable parameters can be set.

In contrast however, a method for operating a dishwasher—a water-containing appliance—has become known from DE 1 96 51 344 A1 in which at the beginning of the program the dishwasher is merely set in operation and the parameters to be set for the continuation of the cleaning process are set depending on at least one detected parameter necessary for the continuation of the cleaning process and influenced by it, wherein at least one parameter is determined by means of a turbidity sensor from the turbidity of the cleaning liquid and whereby a completely automatically controlled method for operating a dishwasher—a water-containing appliance—is created in which incorrect operation by the user is completely eliminated and whereby the power and water consumption of the basically automatic dishwasher is restricted to the lowest possible level.

A disadvantage with using a turbidity sensor according to the method described previously however is that contaminants of the cleaning liquid which are completely dissolved in the cleaning liquid, and in this situation produce no turbidity of the cleaning liquid, naturally cannot be identified. In such a case, therefore, it is not possible to determine the cleaning state of the items to be cleaned using turbidity sensors.

In practice, it has been found that organic substances in particular have this property. Since the items to be cleaned in water-containing appliances, e.g. dishwashers or washing machines, are mainly contaminated with organic residue—food remains, sweat, skin particles etc, detection using a turbidity sensor is not suitable for determining the degree of cleaning of the items to be cleaned in relation to the cleaning from soluble organic contaminants.

### SUMMARY OF THE INVENTION

It is thus the object of the invention to provide a method and a device for operating this method with which contaminants of the cleaning liquid which dissolve completely in the cleaning liquid and in this case produce no turbidity of the cleaning liquid, can be identified.

This object is solved by the method and the water-containing appliance with the features according to the disclosed exemplary embodiments.

According to the method for operating a water-containing appliance according to the invention, in at least one partial program step the degree of contamination of the cleaning liquid is determined by means of a wet combustion and determining the combustion quantity.

In a so-called wet combustion organic components contained in liquids are oxidised (“burnt”). From the combustion quantity, for example, in the case of the cleaning liquid in a dishwasher or washing machine it is possible to determine how much invisible dissolved organic residue is contained in the liquid and thus to determine the degree of cleaning of the items to be cleaned. The invention has succeeded in providing a method with which contaminants of the cleaning liquid which dissolve completely in the cleaning liquid and in this case produce no turbidity of the cleaning liquid can be identified.

According to a preferred feature of the invention, a predetermined quantity of ozone is passed into, passed through and passed out of a partial quantity of the cleaning liquid and the quantity of ozone which is passed out is measured by means of at least one arranged sensor and compared with the quantity of ozone which was passed in. It is known that ozone (O₃) is completely constructed of oxygen atoms and is a high-energy form of oxygen and that ozone reacts rapidly especially with hydrocarbons, the hydrocarbons being converted into CO₂ and eliminated. This explains the use of ozone in sterilising, disinfecting and cleaning agents (see, for example, EP 0 716 686 B1). Ozone is barely soluble in water which is why any falsification of the measurement result by dissolution of the ozone in the liquid to be measured is not to be expected.

The disinfection and deodorising, of an interior of a microwave oven (DE-OS 39 04 418) and the deodorising of a dishwasher using ozone (see DE-OS 39 21 177) are also known. The treatment of supplied washing liquid by ozone for disinfection and deodorising (see DE-OS 35 40 335) is also known.

The method according to the invention is executed with said advantages using the water-containing appliance according to the invention.

The quantity of ozone which is passed out is preferably measured using at least one arranged sensor and compared in a control device with the quantity of ozone which is passed in.

In an especially advantageous fashion the program sequence of the water-containing appliance can be changed on the basis of the result of the comparison. Should it now be found that the quantities are approximately the same, the items to be cleaned are completely freed from organic substances and termination of the cleaning process can be initiated. However, should it be found that the quantities are different, the cleaning process is continued in any case.

Advantageously, on the basis of the result of the comparison, corresponding parameters of the program sequence of the water-containing appliance can be changed according to the difference determined between the quantities. Thus, according to the difference determined between the quantities, i.e., according to the degree of cleaning of the items to be cleaned which has already been achieved, measures can be introduced via the control device of the water-containing appliance, which for example bring about more intensive cleaning, i.e., higher temperature or longer running time etc.

In the water-containing appliance according to the invention it is furthermore advantageous that the residual quantity of ozone which is passed out again, acts directly on the items to be cleaned and there can assist the cleaning action of the cleaning agent used and/or contribute to the deodorising. The cleaning action of the cleaner is better activated by the action of the ozone whereby the use of tensides usually contained in such cleaning agents can be reduced. Ozone also has a bleaching effect especially on contaminants adhering to the items to be cleaned which can be utilized by acting on the items to be cleaned.

The bleaching effect on the contaminants reduces the adhesion of the contaminants on the items to be cleaned and thus brings about faster and better cleaning. The ozone naturally also acts advantageously through the wet combustion in cleaning the remaining cleaning liquid.

According to an advantageous embodiment of the water-containing appliance according to the invention, after the end of the cleaning process ozone is fed into the interior of the appliance whereby a disinfection of the appliance interior and if desired and if these are still present, also of the items to be cleaned is achieved.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a front plan view, in partial section, of a dishwasher in accordance with an exemplary embodiment of the present invention;

FIG. 2 is a front elevational view of a washing machine in accordance with an exemplary embodiment of the present invention; and

FIG. 3 is a schematic of an exemplary embodiment of the present invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

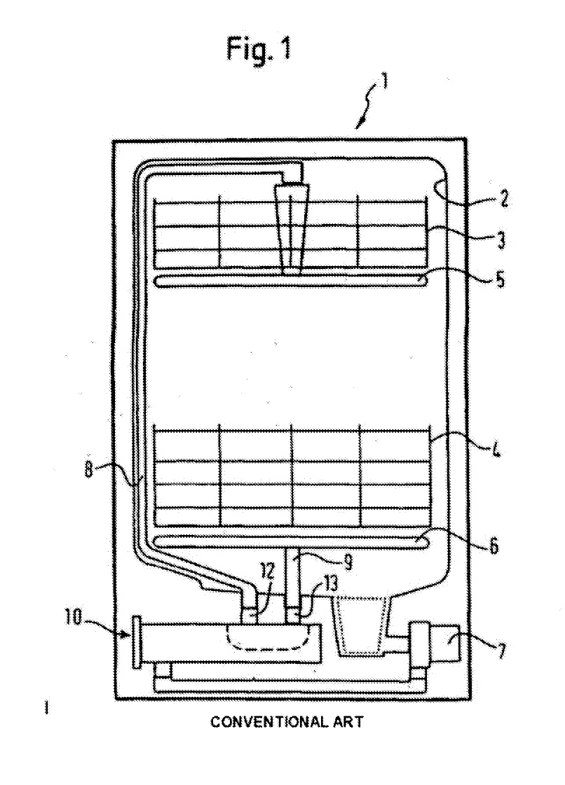

With reference to FIG. 1, a dishwasher 1 includes a washing compartment 2 containing one or more racks, 3 and 4, for holding dishes or other items to be cleaned. Water is driven through the dishwasher 1 by a pump 7. The dishwasher 1 includes a flow heater 10 that receives water from the pump 7 and delivers the heated water into the washing compartment 2 through water line 12 and riser tube 8 to an upper rack spray arm 5 and delivers the heated water as well into the washing compartment 2 through water line 13 and riser tube 9 to a lower spray arm 6.

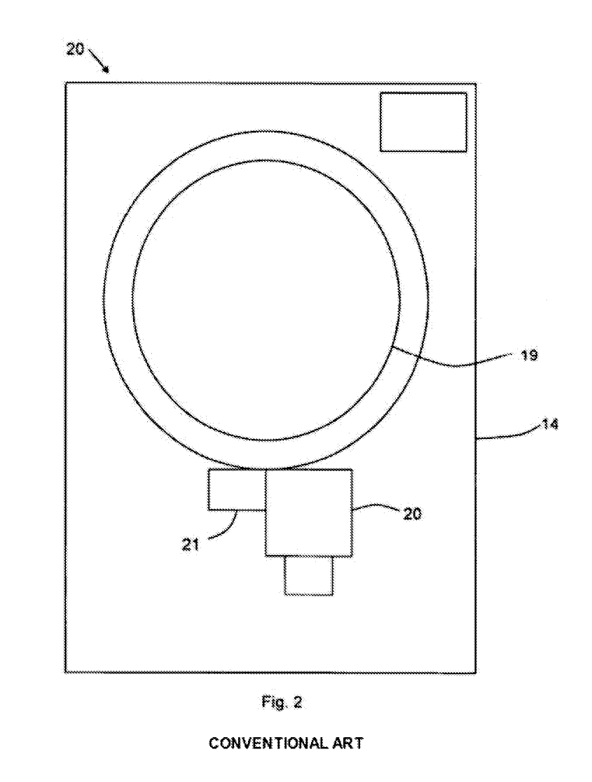

FIG. 2 illustrates a washing machine 10 having a housing 14 and a door 18 connected to the housing 14. The door 18 is mounted with a hinge to pivot with respect to the housing 14 between an open condition and a closed condition. FIG. 2 shows the door 18 in the closed condition. A rotatable drum 19 and a drive device 20 for driving the rotatable drum 19 are disposed within the housing 14. The rotatable drum 19 may receive clothes or laundry items for washing. The washing machine 10 also includes a heating unit 21, such as a gas heating unit or an electric heating unit, disposed within the housing 14 for applying heat to cleaning fluid as it is introduced into the rotating drum 19.

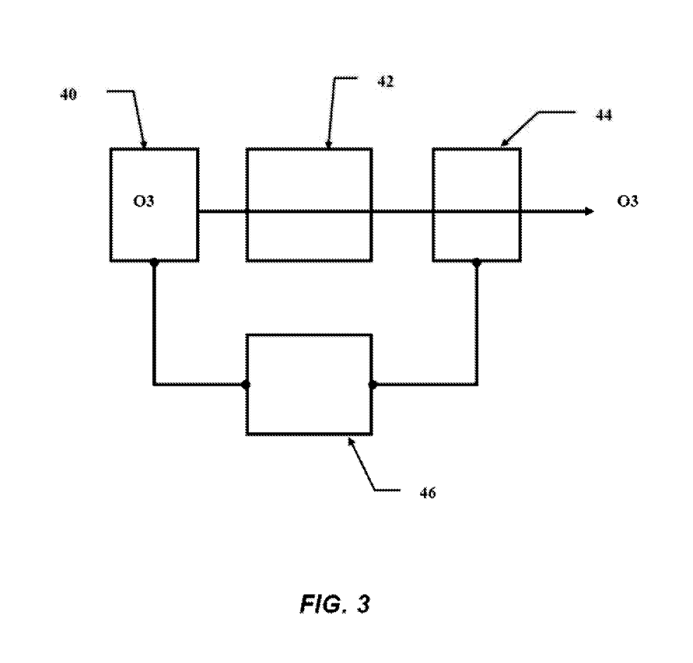

As exemplarily illustrated in FIG. 3, a predetermined quantity of ozone (O₃) 40 is passed into, passed through and passed out of a partial quantity of the cleaning liquid 42 and the quantity of ozone which is passed out is measured by means of at least one arranged sensor 44 and compared with the quantity of ozone which was passed in. It is known that ozone (O₃) is completely constructed of oxygen atoms and is a high-energy form of oxygen and that ozone reacts rapidly especially with hydrocarbons, the hydrocarbons being converted into CO₂ and eliminated. This explains the use of ozone in sterilising, disinfecting and cleaning agents (see, for example, EP 0 716 686 B1). Ozone is barely soluble in water which is why any falsification of the measurement result by dissolution of the ozone in the liquid to be measured is not to be expected.

The quantity of ozone which is passed out is preferably measured using at least one arranged sensor 44 and compared in a control device 46 with the quantity of ozone which is passed in.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. A method of operating a domestic washing appliance, the domestic washing appliance having a washing container, the method comprising:
subjecting a partial quantity of cleaning liquid in the washing container to a wet combustion treatment that combusts organic matter present in the partial quantity of the cleaning liquid;
determining a presence of the organic matter in the cleaning liquid based upon a result of the wet combustion treatment, and
changing a parameter of a program sequence of the domestic washing appliance based on the determined presence of the organic matter in the cleaning liquid.

2. The method of claim 1, wherein a pre-determined quantity of ozone is passed into the partial quantity of the cleaning liquid and a quantity of ozone which is passed out of the partial quantity of the cleaning liquid is measured using an ozone sensor and compared with the pre-determined quantity of ozone which is passed into the partial quantity of the cleaning liquid.

3. The method of claim 1, further comprising:
changing an intensity of a cleaning process of the program sequence of the domestic washing appliance based upon the determined presence of organic matter in the cleaning liquid.

4. The method of claim 1, further comprising:
changing a temperature of the cleaning liquid of the domestic washing appliance based upon the determined presence of organic matter in the cleaning liquid.

5. The method of claim 1, further comprising:
changing a running time of a cleaning process of the program sequence of the domestic washing appliance based upon the determined presence of organic matter in the cleaning liquid.

6. The method of claim 1, wherein the determining the presence of organic matter includes determining a combustion quantity resulting from the wet combustion treatment.

7. The method of claim 2, further comprising:
terminating a cleaning process of the program sequence when the pre-determined quantity of ozone which is passed into the partial quantity of the cleaning liquid is substantially equal to the quantity of ozone which is passed out of the partial quantity of the cleaning liquid.

8. The method of claim 7, further comprising:
disinfecting an interior of the washing container and items to be cleaned after the termination of the cleaning process by feeding ozone into the interior of the washing container after the termination of the cleaning process.

9. The method of claim 2, further comprising:
continuing a cleaning process of the program sequence when the pre-determined quantity of ozone which is passed into the partial quantity of the cleaning liquid is different from the quantity of ozone which is passed out of the partial quantity of the cleaning liquid.

10. The method of claim 2, further comprising:
feeding the quantity of ozone which is passed out of the partial quantity of the cleaning liquid onto items to be cleaned.

11. A method of operating a dishwasher, the dishwasher having a washing container having a rack for holding dishes or other items to be cleaned, a spray device for spraying a cleaning liquid onto the dishes or other items to be cleaned, a wet combustion treatment device for subjecting a partial quantity of the cleaning liquid in the washing container to a wet combustion treatment that combusts organic matter present in the partial quantity of the cleaning liquid and for determining a presence of the organic matter in the cleaning liquid based upon a result of the wet combustion treatment, and a control device for changing a parameter of a program sequence of the dishwasher based upon the determined presence of the organic matter in the cleaning liquid,
the method comprising:
subjecting the partial quantity of cleaning liquid in the washing container to the wet combustion treatment that combusts organic matter present in the partial quantity of the cleaning liquid;
determining the presence of the organic matter in the cleaning liquid based upon the result of the wet combustion treatment; and
controlling the program sequence of the dishwasher based upon the determined presence of the organic matter in the cleaning liquid.

12. The method of claim 11, further comprising:
passing a pre-determined quantity of ozone into the partial quantity of the cleaning liquid;
measuring a quantity of ozone which is passed out of the partial quantity of the cleaning liquid using at least one ozone sensor; and
comparing the measured quantity of ozone with the pre-determined quantity of ozone which is passed into the partial quantity of the cleaning liquid using the control device.

13. The method of claim 12, further comprising:
changing corresponding parameters of the program sequence of the dishwasher based on a difference determined between the pre-determined quantity of ozone which is passed into the partial quantity of the cleaning liquid and the quantity of ozone which is passed out of the partial quantity of the cleaning liquid.

14. The method of claim 12, further comprising:
passing the quantity of ozone which is passed out of the partial quantity of the cleaning liquid onto items to be cleaned.

15. The method of claim 11, further comprising:
feeding ozone into an interior of the washing container after an end of a cleaning process of the program sequence.

16. The method of claim 12, further comprising:
terminating, using the control device, a cleaning process of the program sequence when the pre-determined quantity of ozone which is passed into the partial quantity of the cleaning liquid is substantially equal to a quantity of ozone which is passed out of the partial quantity of the cleaning liquid.

17. The method of claim 16, further comprising:
passing ozone into an interior of the washing container for disinfecting the interior of the washing container after the termination of the cleaning process.

18. The method of claim 12, further comprising:
continuing, using the control device, a cleaning process of the program sequence when the pre-determined quantity of ozone which is passed into the partial quantity of the cleaning liquid is different from the quantity of ozone which is passed out of the partial quantity of the cleaning liquid.

19. The method of claim 11, wherein the controlling the program sequence of the washing machine includes controlling an intensity of a cleaning process of the program sequence of the dishwasher.

20. The method of claim 11, wherein the controlling the program sequence of the washing machine includes controlling a temperature of the cleaning liquid of the dishwasher.

21. The method of claim 11, wherein the controlling the program sequence of the washing machine includes controlling a running time of a cleaning process of the program sequence of the dishwasher.

22. A method of operating a washing machine comprising a housing and a door coupled to the housing, a washing container mounted in the housing and accessible through the door, a rotatable drum rotatably mounted in the washing container for receiving laundry items to be washed, a drive device for rotating the rotatable drum, a wet combustion treatment device that subjects a partial quantity of a cleaning liquid in the washing container to a wet combustion treatment by combusting organic matter present in the partial quantity of the cleaning liquid to characterize a presence of the organic matter in the cleaning liquid, a control device that changes a parameter of a program sequence of the washing machine based upon the characterizing of the presence of the organic matter in the cleaning liquid, wherein the wet combustion treatment device passes a pre-determined quantity of ozone in to the partial quantity of the cleaning liquid, and a sensor that measures a quantity of ozone which is passed out of the partial quantity of the cleaning liquid, wherein the control device compares the quantity of ozone which is passed out of the partial quantity of the cleaning liquid to the pre-determined quantity of ozone which is passed in to the partial quantity of the cleaning liquid,
the method comprising:
subjecting the partial quantity of cleaning liquid in the washing container to the wet combustion treatment that combusts organic matter present in the partial quantity of the cleaning liquid;
determining the presence of the organic matter in the cleaning liquid based upon the result of the wet combustion treatment; and
controlling the program sequence of the washing machine based upon the determined presence of the organic matter in the cleaning liquid.
